(19) United States
(12) Patent Application Publication
(10) Pub. No.: US 2025/0046546 A1
(43) Pub. Date: Feb. 6, 2025

(54) CONTROL APPARATUS

(71) Applicant: Alps Alpine Co., Ltd., Tokyo (JP)

(72) Inventors: Norimasa OKANISHI, Miyagi-ken (JP); Masahiro ASANO, Miyagi-ken (JP); Hiroshi SASAKI, Miyagi-ken (JP); Tatsuaki KAWASE, Miyagi-ken (JP)

(21) Appl. No.: 18/927,003

(22) Filed: Oct. 25, 2024

Related U.S. Application Data
(63) Continuation of application No. PCT/JP2023/006386, filed on Feb. 22, 2023.

(30) Foreign Application Priority Data
May 17, 2022 (JP) 2022-081013

(51) Int. Cl. H01H 25/04

(52) U.S. Cl. CPC H01H 25/04

(57) ABSTRACT

A control apparatus includes a lever configured to be tilted, a first resistor extending in a first direction on a surface of a board, a first operatively connected member configured to rotate as the lever is tilted, and a first holder holding a first slider and sliding the first slider on the first resistor by moving in the first direction as the first operatively connected member rotates. The first drive transmitting portion includes a first protrusion integrated with the first holder and protruding in a second direction perpendicular to the first direction, and a first engaging portion integrated with the first operatively connected member and including a pair of clamping pieces that clamps the first protrusion from opposite sides. The first protrusion includes a protruding portion having a third direction component perpendicular to the first direction and the second direction and protruding between the pair of clamping pieces.

### CLAIM OF PRIORITY

This application is a Continuation of International Application No. PCT/JP2023/006386 filed on Feb. 22, 2023, which claims benefit of Japanese Patent Application No. 2022-081013 filed on May 17, 2022. The entire contents of each application noted above are hereby incorporated by reference.

### BACKGROUND OF THE INVENTION

### 1. Field of the Invention

The present invention relates to a control apparatus for input by tilting an operating member in a desired direction.

### 2. Description of the Related Art

International Publication No. WO2021/246003 discloses a control apparatus that performs input by tilting an operating member such as a control lever and that enhances the accuracy of returning the value of the output signal to a value indicating its neutral state when the lever returns to the neutral state. The control apparatus includes a lever configured to be tilted, a strip-shaped first resistor extending in a first direction on a surface of a board, a first actuator that rotates as the lever is tilted, and a first holder holding a first slider, the first holder sliding the first slider on a surface of the first resistor by moving in the first direction via a first drive transmitting portion as the first actuator rotates. In the control apparatus, the first drive transmitting portion includes a first columnar protrusion integrated with the first holder and protruding in a second direction perpendicular to the first direction; and a first engaging portion integrated with the first actuator and including a pair of clamping pieces that clamps the first protrusion from opposite sides in the first direction.

In the control apparatus that detects the tilting motion of the operating member, the operating member may be subjected to external forces, including strong impacts such as those experienced during a fall, which may cause the pair of clamping pieces to collide with the bottom, causing damage. For this reason, it is ideal to design the pair of clamping pieces as short as possible so as not to collide with the bottom, even when subjected to the impacts as described above. However, the short clamping pieces would release the engagement when the operating member is tilted and exceeds its upper limit tilt angle. It is required that even if the operating member is subjected to such external forces, a collision between the pair of clamping pieces and the bottom be avoided, and that the engagement between the members are not released within the range of the elastic deformation of a member that is operatively connected to the operating member.

### SUMMARY OF THE INVENTION

The present invention provides a control apparatus configured to maintain the reliable operative connection (interlocking) relationship between the component members even if a force exceeding the upper limit tilt angle of the operating member is exerted on the operating member.

A control apparatus according to one embodiment of the present invention includes a lever configured to be tilted, a strip-shaped first resistor extending in a first direction on a surface of a board, a first operatively connected (operably-coupled) member configured to rotate as the lever is tilted, and a first holder holding a first slider, the first holder sliding the first slider on a surface of the first resistor by moving in the first direction via a first drive transmitting portion as the first operatively connected member rotates, wherein the first drive transmitting portion includes a first protrusion integrated with the first holder and protruding in a second direction perpendicular to the first direction and a first engaging portion integrated with the first operatively connected member and including a pair of clamping pieces that clamps the first protrusion from opposite sides in the first direction, and wherein the first protrusion includes a protruding portion having a third direction component perpendicular to the first direction and the second direction and protruding between the pair of clamping pieces.

With this configuration, even if the first operatively connected member is tilted beyond a predetermined maximum tilt angle due to impact or other factors, an outer clamping piece and the first protrusion come into contact to prevent the first protrusion from moving outward, thereby preventing the first protrusion from dropping out.

In the control apparatus, when the first operatively connected member is at a predetermined maximum tilt angle, the protruding portion may be configured to protrude to a region not in contact with the inner surface of the outer clamping piece and nearer to a rotation shaft of the first operatively connected member than an outer inner end that is an end of an inner surface of an outer clamping piece of the pair of clamping pieces in the third direction. Thus, even if the outer clamping piece is tilted more than expected, the protruding portion at the first protrusion may be brought into contact with the inner surface of the outer clamping piece, thereby preventing the first protrusion from dropping out.

In the control apparatus, with the pair of clamping pieces not clamping the first protrusion, in a state in which a distance between one of the pair of clamping pieces and another of the clamping pieces is smaller than a diameter of the first protrusion, and a gap between the pair of clamping pieces extends along the third direction, one of the clamping pieces may be elastically deformed to clamp the first protrusion. With this configuration, the clearance between the pair of clamping pieces and the first protrusion is eliminated, thereby eliminating the wobbling movement between the first protrusion and the first engaging portion.

In the control apparatus, the protruding portion may protrude toward the rotation shaft of the first operatively connected member in the third direction beyond the outer inner end in a state in which the outer clamping piece of the first operatively connected member at the maximum tilt angle is most outwardly elastically deformed. Even if the outer clamping piece is elastically deformed to the limit leading to plastic deformation when the operating member is at the maximum tilt angle, setting the shape of the protruding portion so that the outer clamping piece and the protruding portion come into contact when the maximum tilt angle is exceeded stably prevents the first protrusion from dropping out.

In the control apparatus, as seen along the second direction, a contour of the first protrusion may be circular on a side facing the board in the third direction, and a contour of the protruding portion may protrude beyond an imaginary line of the circle extending toward the rotation shaft of the first operatively connected member in the third direction. This configuration prevents the first protrusion from dropping out more stably than a case where the first protrusion seen along the second direction is circular.

In the control apparatus, as seen along the second direction, the first protrusion may include a recessed portion provided outside the protruding portion in the first direction and having a contour passing inside the imaginary line. With this configuration, when the pair of clamping pieces comes into contact with the first protrusion while rotating, relief for the contact between the first protrusion and the pair of clamping pieces is provided.

According to embodiments of the present invention, a control apparatus configured to maintain the reliable operative connection relationship between the members even if a force exceeding the upper limit tilt angle of the operating member is exerted on the operating member is provided.

### BRIEF DESCRIPTION OF THE DRAWINGS

FIG. 1 is an external perspective view of a control apparatus according to one embodiment;

FIG. 2 is an external perspective view of the control apparatus according to one embodiment (with the case removed);

FIG. 3 is an exploded perspective view of the control apparatus according to one embodiment;

FIG. 4 is a cross-sectional view of the control apparatus according to one embodiment;

FIG. 5 is a plan view of a flexible printed circuit (FPC) of the control apparatus according to one embodiment;

FIG. 6 is a diagram illustrating the arrangement of sliders on the surface of the FPC according to one embodiment;

FIG. 7 is a diagram illustrating the engaging state of the sliders and operatively connected members according to one embodiment as seen from above;

FIG. 8 is a diagram illustrating the engaging state of the sliders and the operatively connected members according to one embodiment as seen from below;

FIG. 9 is a cross-sectional view of a first drive transmitting portion according to one embodiment illustrating the configuration thereof;

FIG. 10 is a perspective view of the first drive transmitting portion illustrating the configuration thereof;

FIG. 11A is a schematic diagram illustrating the contour of a first protrusion;

FIG. 11B is a schematic diagram illustrating the contour of the first protrusion;

FIG. 12 is a schematic diagram illustrating the operation of the first drive transmitting portion;

FIG. 13 is a schematic diagram illustrating the contact state of a pair of clamping pieces and the first protrusion;

FIG. 14 is a schematic diagram illustrating the contact state of the pair of clamping pieces and the first protrusion; and

FIG. 15 is a schematic diagram illustrating the contact state of the pair of clamping pieces and the first protrusion.

### DESCRIPTION OF THE PREFERRED EMBODIMENTS

An embodiment of the present invention will be described in detail hereinbelow with reference to the accompanying drawings. In the following description, like components are identified by the same reference signs, and the description of previously explained components will be omitted as appropriate.

### <Outline of Control Apparatus 100>

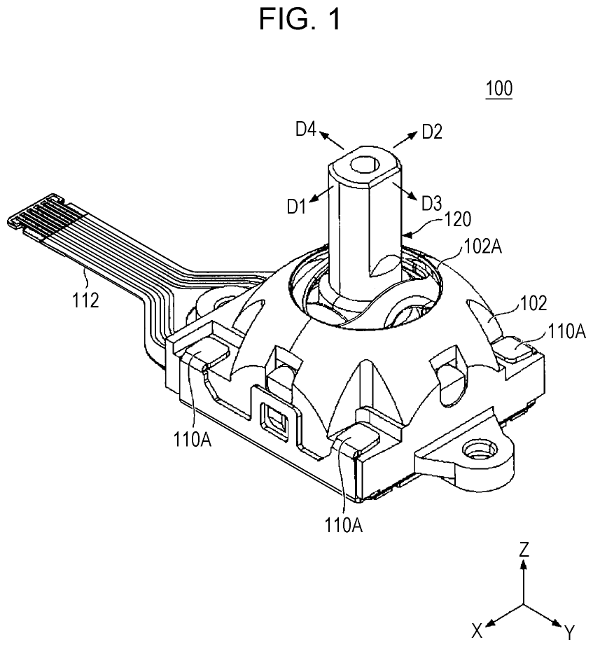

FIG. 1 is an external perspective view of a control apparatus 100 according to one embodiment. In the following description, the Z-axis direction in the drawings is defined as the vertical direction, the X-axis direction is defined as the front-back direction, and the Y-axis direction is defined as the lateral direction for the sake of convenience. The X-axis direction in the drawings is defined as an example of “first direction”, the Y-axis direction is defined as an example of “second direction”, and the Z-axis direction is defined as an example of “third direction”.

The control apparatus 100 illustrated in FIG. 1 is used as a controller or a similar device for a game machine or the like. As illustrated in FIG. 1, the control apparatus 100 includes a lever 120, which is a columnar operating member configured to be tilted and extending upward from an opening 102A of a case 102. The control apparatus 100 is capable of tilting not only in the front-back direction (in the directions of arrows D1 and D2 in the drawings) and the lateral direction (in the directions of arrows D3 and D4) with the lever 120 but also in all the directions between the directions. The control apparatus 100 is configured to output an operation signal corresponding to the tilting operation of the lever 120 (the tilting direction and the tilting angle) outward via a flexible printed circuit (FPC) 112.

### <Configuration of Control Apparatus 100>

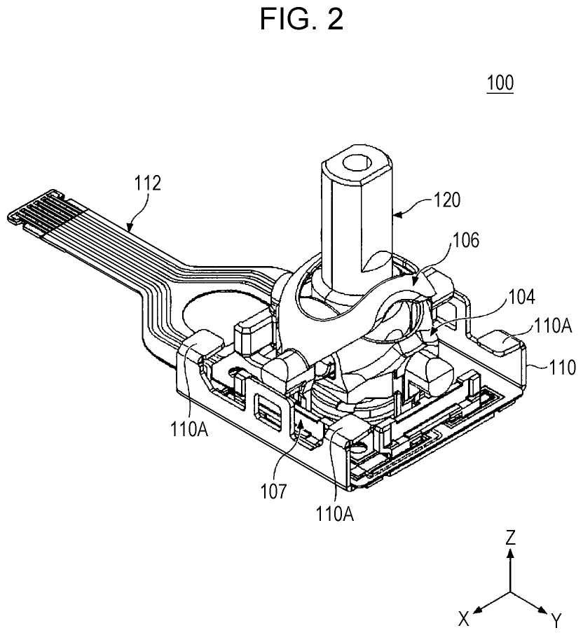

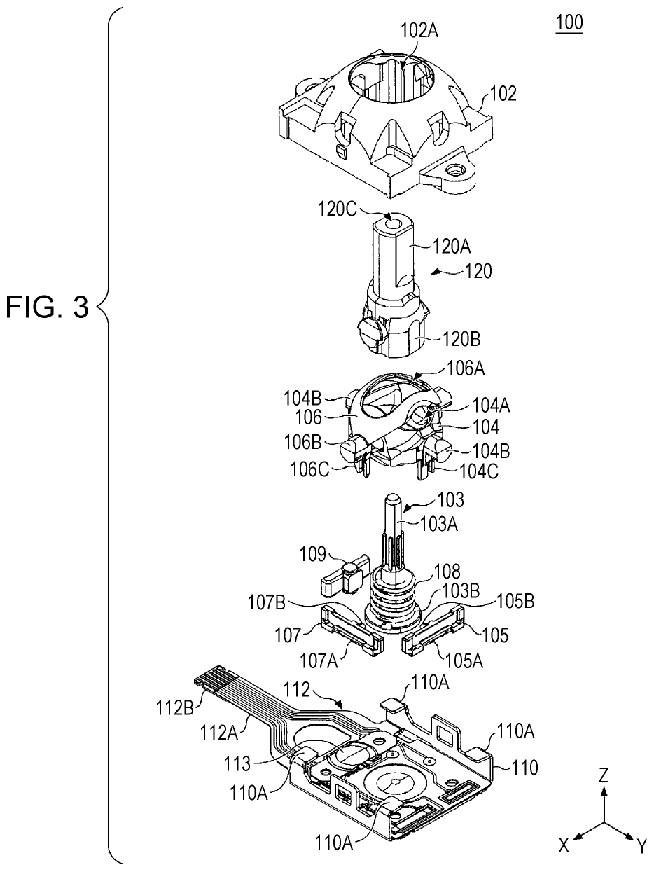

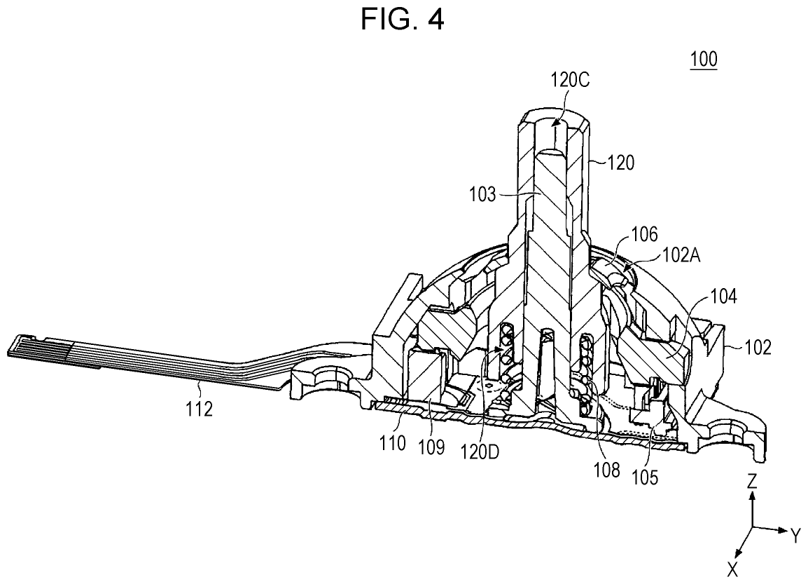

FIG. 2 is an external perspective view of the control apparatus 100 according to one embodiment (with the case 102 removed). FIG. 3 is an exploded perspective view of the control apparatus 100 according to one embodiment. FIG. 4 is a cross-sectional view of the control apparatus 100 according to one embodiment.

As illustrated in FIGS. 2 to 4, the control apparatus 100 includes the case 102, the lever 120, a first operatively connected member 104, a second operatively connected member 106, a shaft 103, a spring 108, a first holder 105, a second holder 107, a pressing member 109, a frame 110, the FPC 112, and a metal sheet 113.

The case 102 protrudes upward in a dome shape. The case 102 houses the components. The case 102 has an opening 102A that is circular in plan view from above at the top of the dome-shaped portion.

The lever 120 is an operating member to be tilted by an operator. The lever 120 includes a lever portion 120A and a base 120B. The lever portion 120A is a substantially columnar portion extending upward through the opening 102A of the case 102 and being tilted by the operator. The base 120B is a substantially columnar portion that supports the lower end of the lever portion 120A in the case 102 and rotates as the lever portion 120A is tilted.

The first operatively connected member 104 protrudes upward in a curved dome shape and has an elongate-hole shaped opening 104A extending in the lateral direction (in the Y-axis direction in the drawing) along the curved shape. The first operatively connected member 104 includes a rotation shaft 104B at each of the opposite ends in the lateral direction. Since the rotation shafts 104B are supported by the case 102, the first operatively connected member 104 is rotatable in the front-back direction (in the X-axis direction) about the rotation shaft 104B as the lever 120 is tilted in the front-back direction (in the X-axis direction).

The second operatively connected member 106 is provided over the first operatively connected member 104. The second operatively connected member 106 protrudes upward in a curved shape and has an elongate-hole shaped opening 106A extending in the front-back direction (in the X-axis direction) along the curved shape. The second operatively connected member 106 includes a rotation shaft 106B at each of the opposite ends in the front-back direction. Since the rotation shafts 106B are supported by the case 102, the second operatively connected member 106 is rotatable in the lateral direction (in the Y-axis direction) about the rotation shaft 106B as the lever 120 is tilted in the lateral direction (in the Y-axis direction).

The first holder 105 is provided on the right side (on the positive side of the Y-axis) of the first operatively connected member 104. The first holder 105 holds the first slider 105A at the bottom. The first holder 105 has a long shape extending in the sliding direction (X-axis direction) of the first slider 105A. The first holder 105 is slidable in the sliding direction (X-axis direction) of the first slider 105A. The first holder 105 has a first protrusion 105B protruding toward the first operatively connected member 104 at the center of the side adjacent to the first operatively connected member 104 (on the negative side of the Y-axis).

The second holder 107 is provided in front (on the positive side of the X-axis) of the second operatively connected member 106. The second holder 107 holds the second slider 107A at the bottom. The second holder 107 has a long shape extending in the sliding direction (Y-axis direction) of the second slider 107A. The second holder 107 is slidable in the sliding direction (Y-axis direction) of the second slider 107A. The second holder 107 has a second protrusion 107B protruding toward the second operatively connected member 106 at the center of the side adjacent to the second operatively connected member 106 (on the negative side of the X-axis).

As illustrated in FIGS. 2 to 4, the first operatively connected member 104 and the second operatively connected member 106 overlap with each other in such a manner that the opening 104A and the opening 106A cross each other. The first operatively connected member 104 and the second operatively connected member 106 are installed in the case 102 together with the base 120B of the lever 120, in a state where the first operatively connected member 104 and the second operatively connected member 106 overlap with each other and are engaged with the base 120B of the lever 120, with the lever portion 120A passing through the opening 104A and the opening 106A.

The first operatively connected member 104 includes a first engaging portion 104C protruding downward from the rotation shaft 104B on the positive side of the Y-axis. The first engaging portion 104C engages with the first protrusion 105B of the first holder 105. When the lever 120 is tilted in the front-back direction (X-axis direction), the first operatively connected member 104 rotates in the front-back direction together with the base 120B of the lever 120 to cause the first engaging portion 104C to slide the first holder 105 in the front-back direction. This changes the electrical connection between the first slider 105A held at the bottom of the first holder 105 and resistors 116 and 117 provided on the FPC 112, and an operation signal based on the resistance value corresponding to the tilting operation of the lever 120 in the front-back direction (the tilting direction and the tilting angle) is output from a connecting portion 112B of the FPC 112.

The second operatively connected member 106 includes a second engaging portion 106C protruding downward from the rotation shaft 106B on the positive side of the X-axis. The second engaging portion 106C engages with the second protrusion 107B of the second holder 107. When the lever 120 is tilted in the lateral direction (Y-axis direction), the second operatively connected member 106 rotates in the lateral direction together with the base 120B of the lever 120 to cause the second engaging portion 106C to slide the second holder 107 in the lateral direction. This changes the electrical connection between the second slider 107A held at the bottom of the second holder 107 and resistors 115 and 117 provided on the FPC 112, and an operation signal based on the resistance value corresponding to the tilting operation of the lever 120 in the lateral direction (the tilting direction and the tilting angle) is output from the connecting portion 112B of the FPC 112.

The shaft 103 includes a shaft portion 103A and a bottom plate 103B. The shaft portion 103A is a round-bar-like portion passing through the through-hole 120C of the lever 120. The bottom plate 103B is a disc-like portion integrated with the lower end of the shaft portion 103A.

The spring 108, through which the shaft portion 103A of the shaft 103 passes, is installed in an opening 120D (see FIG. 4) at the bottom of the lever 120 (on the negative side of the Z-axis) together with the shaft 103. The spring 108 urges the lever 120 upward, and the bottom plate 103B of the shaft 103 downward. With this configuration, when the tilting operation of the lever 120 by the operator is released, the spring 108 pushes the bottom plate 103B of the shaft 103 against the upper surface and the central portion of the frame 110 to bring the bottom plate 103B into the horizontal state, thereby returning the lever 120 to its neutral position.

When the lever 120 is pushed downward, the pressing member 109 is pushed downward by the rotation shaft 104B on the negative side of the Y-axis of the first operatively connected member 104 to push the metal sheet 113 provided on the FPC 112 downward to elastically deform the metal sheet 113, thereby bringing a switch circuit formed on the FPC 112 into a conduction state. This causes the FPC 112 to output a switch-on signal indicating that the lever 120 has been pushed downward.

The frame 110 is a metal-made flat member that closes the opening at the bottom of the case 102. For example, the frame 110 is produced using various processing methods for metal plates (for example, a punching process and a bending process). The frame 110 is provided with a pair of tubs 110A at each of the front edge (on the positive side of the X-axis) and the rear edge (on the negative side of the X-axis). As illustrated in FIG. 1, the frame 110 is securely joined to the case 102 by the tubs 110A engaging with the edge of the case 102.

The FPC 112 is an example of “board”, which is a flexible film-like wiring member. The FPC 112 includes an extending portion 112A extending from the upper surface of the frame 110 to a side of the frame 110 (in the negative direction of the Y-axis) and is connected to the external device by a connecting portion 112B provided at an end of the extending portion 112A. The FPC 112 transmits an operation signal corresponding to the operation of the lever 120 (a tilting operation and a pushing operation) outward. The FPC 112 is produced by covering the opposite surfaces of a strip-shaped conductor wire (for example, copper foil) with a flexible insulating film-like material (for example, polyimide resin or polyethylene terephthalate [PET]).

### <Configuration of FPC 112>

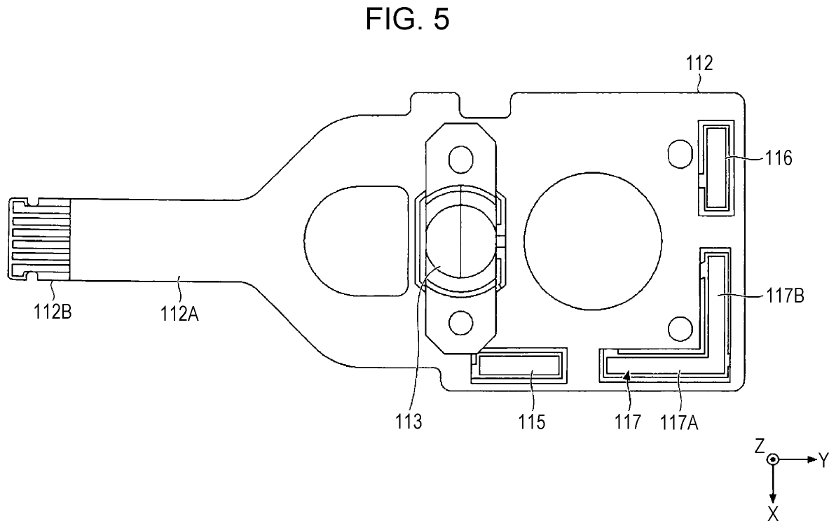

FIG. 5 is a plan view of the FPC 112 of the control apparatus 100 according to one embodiment. As illustrated in FIG. 5, the surface of the FPC 112 is provided with planar and strip-shaped resistors 115, 116, and 117. For example, each of the resistors 115, 116, and 117 is printed as a thin film from a carbon fiber material.

The resistor 115 is provided along the front edge (on the positive side of the X-axis) of the FPC 112. The resistor 115 has a strip shape extending linearly in the lateral direction (Y-axis direction).

The resistor 116 is provided along the right edge (on the positive side of the Y-axis) of the FPC 112. The resistor 116 has a string shape extending linearly in the front-back direction (X-axis direction).

The resistor 117 is provided along the front (on the positive side of the X-axis) and right (on the positive side of the Y-axis) corner of the FPC 112. The resistor 117 has an L-shape consisting of a straight portion 117A and a straight portion 117B. The straight portion 117A has a strip shape extending linearly in the lateral direction (Y-axis direction). The straight portion 117B has a strip shape extending in the front-back direction (X-axis direction).

### <Configuration on Sliding of Sliders 105A and 107A>

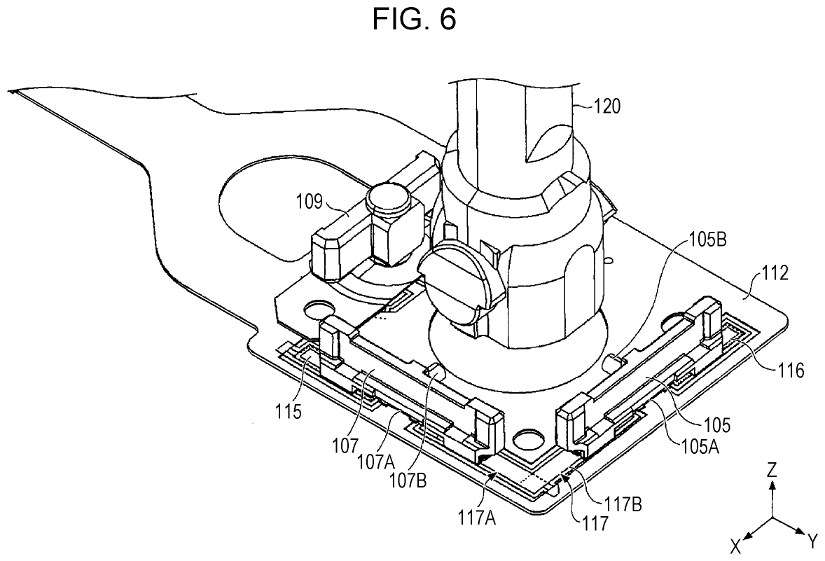

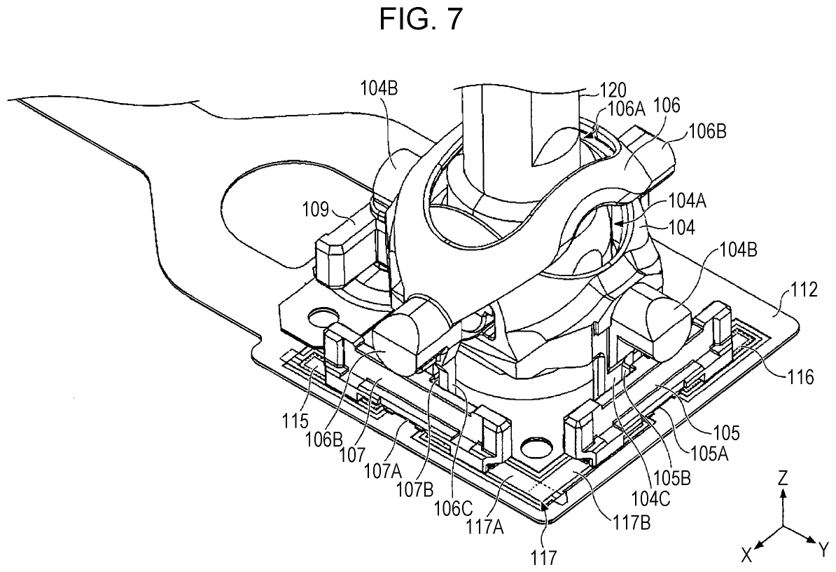

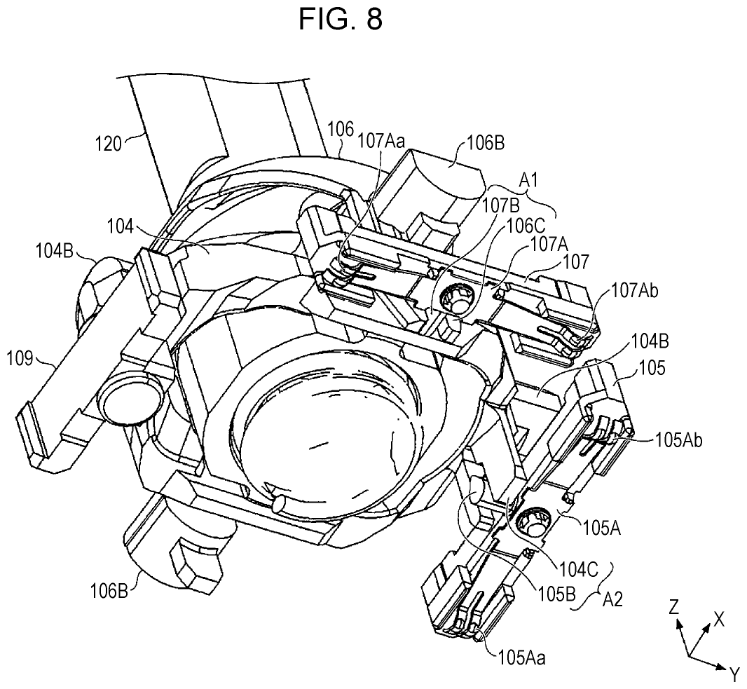

FIG. 6 is a diagram illustrating the arrangement of the first and second sliders 105A and 107A on the surface of the FPC 112 according to one embodiment. FIG. 7 is a diagram illustrating the engaging state of the first and second sliders 105A and 107A and the first and second operatively connected members 104 and 106 according to one embodiment as seen from above. FIG. 8 is a diagram illustrating the engaging state of the first and second sliders 105A and 107A and the first and second operatively connected members 104 and 106 according to one embodiment as seen from below.

As illustrated in FIG. 5, on the surface of the FPC 112, the straight portion 117B of the resistor 117 and the resistor 116 are disposed away from each other, linearly in the X-axis direction along the right edge (on the positive side of the Y-axis) of the FPC 112. As illustrated in FIG. 6, the first holder 105 is disposed across the surface of the straight portion 117B of the resistor 117 and the surface of the resistor 116. The bottom of the first holder 105 is provided with the metal-made leaf-spring-shaped first slider 105A. The first slider 105A slides on the surfaces of the straight portion 117B and the resistor 116 (an example of “first resistor”) as the first holder 105 moves in the X-axis direction. Specifically, a contact portion 105Aa provided at the end of the first slider 105A on the negative side of the X-axis (see FIG. 8) slides on the surface of the resistor 116. Furthermore, a contact portion 105Ab provided at the end of the first slider 105A on the positive side of the X-axis (see FIG. 8) slides on the surface of the straight portion 117B.

As illustrated in FIG. 5, on the surface of the FPC 112, the straight portion 117A of the resistor 117 and the resistor 115 are disposed away from each other, linearly in the Y-axis direction along the front edge (on the positive side of the X-axis) of the FPC 112. As illustrated in FIG. 6, the second holder 107 is disposed across the surface of the straight portion 117A of the resistor 117 and the surface of the resistor 115. The bottom of the second holder 107 is provided with the metal-made leaf-spring-shaped second slider 107A. The second slider 107A slides on the surfaces of the straight portion 117A and the resistor 115 (an example of “second resistor”) as the second holder 107 moves in the Y-axis direction. Specifically, a contact portion 107Aa provided at the end of the second slider 107A on the negative side of the Y-axis (see FIG. 8) slides on the surface of the resistor 115. Furthermore, a contact portion 107Ab provided at the end of the second slider 107A on the positive side of the Y-axis (see FIG. 8) slides on the surface of the straight portion 117A.

As illustrated in FIGS. 6 to 8, a first protrusion 105B protruding toward the first operatively connected member 104 is provided at the center of the side of the first holder 105 adjacent to the first operatively connected member 104 (on the negative side of the Y-axis). As illustrated in FIGS. 6 to 8, the first protrusion 105B engages with the first engaging portion 104C of the first operatively connected member 104. The first protrusion 105B of the first holder 105 and the first engaging portion 104C of the first operatively connected member 104 constitute a second drive transmitting portion A2. With this configuration, the first holder 105 moves in the front-back direction (X-axis direction) via the second drive transmitting portion A2 as the first operatively connected member 104 rotates. At that time, the first slider 105A held by the first holder 105 slides in the front-back direction (X-axis direction) on the surfaces of the straight portion 117B and the resistor 116.

As illustrated in FIGS. 6 to 8, a second protrusion 107B protruding toward the second operatively connected member 106 is provided at the center of the side of the second holder 107 adjacent to the second operatively connected member 106 (on the negative side of the X-axis). As illustrated in FIGS. 6 to 8, the second protrusion 107B engages with the second engaging portion 106C of the second operatively connected member 106. The second protrusion 107B of the second holder 107 and the second engaging portion 106C of the second operatively connected member 106 constitute a first drive transmitting portion A1. With this configuration, the second holder 107 moves in the lateral direction (Y-axis direction) via the first drive transmitting portion A1 as the second operatively connected member 106 rotates. At that time, the second slider 107A held by the second holder 107 slides in the lateral direction (Y-axis direction) on the surfaces of the straight portion 117A and the resistor 115.

With this configuration, in the control apparatus 100 according to one embodiment, the second slider 107A slides in the lateral direction (Y-axis direction) on the surfaces of the straight portion 117A and the resistor 115 as the lever 120 is tilted in the lateral direction (Y-axis direction). This causes the resistance value between a terminal connected to the resistor 117 and a terminal connected to the resistor 115 to change according to the amount of movement of the second slider 107A (that is, the tilting angle of the lever 120). The external device can detect the tilting operation and the tilting angle of the lever 120 in the lateral direction (Y-axis direction) based on the change in the resistance value between the terminals.

In the control apparatus 100 according to one embodiment, the first slider 105A slides in the front-back direction (X-axis direction) on the surfaces of the straight portion 117B and the resistor 116 as the lever 120 is tilted in the front-back direction (X-axis direction). This causes the resistance value between a terminal connected to the resistor 117 and a terminal connected to the resistor 116 to change according to the amount of movement of the first slider 105A (that is, the tilting angle of the lever 120). The external device can detect the tilting operation and the tilting angle of the lever 120 in the front-back direction (X-axis direction) based on the change in the resistance value between the terminals.

### <Configuration of First Drive Transmitting Portion A1>

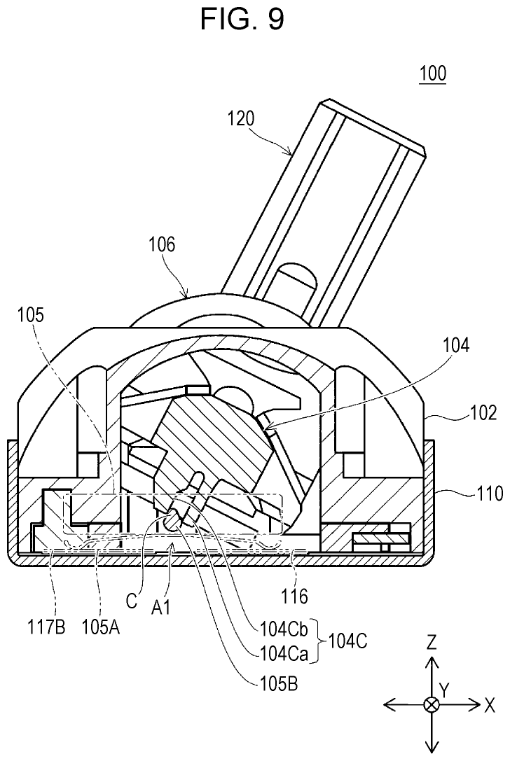

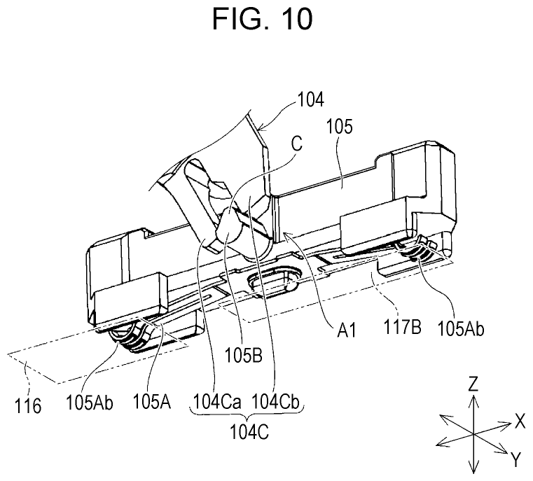

FIG. 9 is a cross-sectional view of the first drive transmitting portion A1 according to one embodiment illustrating the configuration thereof. FIG. 10 is a perspective view of the first drive transmitting portion A1 illustrating the configuration thereof. As illustrated in FIGS. 9 and 10, the first drive transmitting portion A1 includes the first protrusion 105B of the first holder 105 and the first engaging portion 104C of the first operatively connected member 104. As illustrated in FIG. 9, the first engaging portion 104C includes a pair of clamping pieces 104Ca and 104Cb that clamps the first protrusion 105B from the both sides in the front-back direction (X-axis direction). The first protrusion 105B clamped between the pair of clamping pieces 104Ca and 104Cb includes a protruding portion C having a Z-direction component and protruding between the pair of clamping pieces 104Ca and 104Cb.

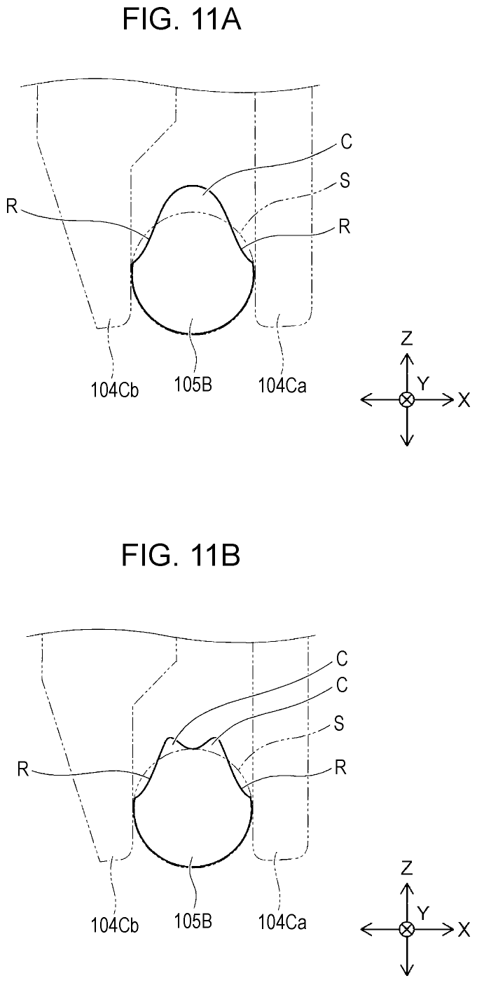

FIGS. 11A and 11B are schematic diagrams illustrating the contour of the first protrusion 105B. FIGS. 11A and 11B are plan views of the first protrusion 105B seen in the Y-direction.

The contour of the first protrusion 105B illustrated in FIG. 11A is circular at the lower part (approximately semicircular with the lower part being circular), the upper part of which protrudes above the imaginary line S of the lower semicircle (toward the rotation shaft 104B of the first operatively connected member 104 in a third direction [Z-axis direction]). This protruding portion is the protruding portion C.

The contour of the first protrusion 105B illustrated in FIG. 11B is semicircular at the lower part, as in FIG. 11A, but two protruding portions C at the upper part, protruding above the imaginary line S of the lower semicircle.

The contour of the first protrusion 105B may have any shape that is semicircular at the lower part and has the protruding portion C protruding above the imaginary line S at the upper part. In any example, the contour of the first protrusion 105B may have recessed portions R passing inside the imaginary line S of the circle. In this embodiment, the recessed portions R continue to the protruding portion C.

The pair of clamping pieces 104Ca and 104Cb may be configured such that the distance between one clamping piece 104Ca and the other clamping piece 104Cb is smaller than the diameter of the first protrusion 105B, with the first protrusion 105B not clamped.

For example, one clamping piece 104Ca has greater elasticity than the other clamping piece 104Cb because its width in the front-back direction (X-axis direction) is smaller than that of the other clamping piece 104Cb.

With this configuration, when the first protrusion 105B is fitted between one clamping piece 104Ca and the other clamping piece 104Cb, one clamping piece 104Ca is elastically deformed to the positive side of the X-axis, allowing the pair of clamping pieces 104Ca and 104Cb to securely clamp the first protrusion 105B.

By clamping the first protrusion 105B through such elastic deformation of the pair of clamping pieces 104Ca and 104Cb, the clearance between the first protrusion 105B of the first holder 105 and the first engaging portion 104C of the first operatively connected member 104 is eliminated, thereby eliminating the wobbling movement between the first protrusion 105B and the first engaging portion 104C.

This allows the first holder 105 to return to its neutral position when the lever 120 returns to the neutral position in the X-axis direction, and an output signal indicating the neutral state to be provided as an output signal in the X-axis direction. This therefore enhance the accuracy of returning the output value to the value indicating the neutral state in the X-axis direction when the lever 120 returns to the neutral state in the X-axis direction.

In particular, with a configuration in which the other clamping piece 104Cb is less susceptible to elastic deformation, setting the other clamping piece 104Cb at the reference position allows the first holder 105 to be returned to the neutral position with higher accuracy.

Furthermore, by elastically deforming one clamping piece 104Ca, the clamping force of the pair of clamping pieces 104Ca and 104Cb for the first protrusion 105B may be suitably adjusted, thereby eliminating or reducing the scrape of the outer peripheral surface of the first protrusion 105B.

### <Operation of First Drive Transmitting Portion A1>

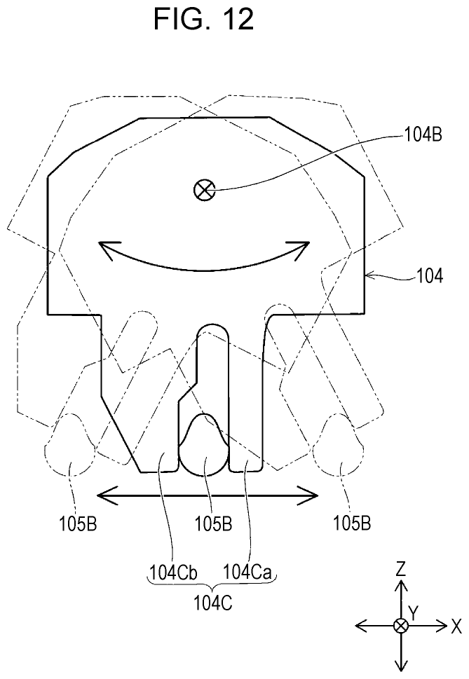

FIG. 12 is a schematic diagram illustrating the operation of the first drive transmitting portion A1. As illustrated in FIG. 12, the first operatively connected member 104 rotates in the front-back direction about the rotation shaft 104B in cooperation with the tilting operation of the lever 120 (see FIG. 9) in the front-back direction (the X-axis direction). FIG. 12 illustrates the two states of the first operatively connected member 104 at predetermined maximum tilt angles and the first protrusion 105B in the individual states using two-dot chain lines. With the rotation of the first operatively connected member 104, the pair of clamping pieces 104Ca and 104Cb of the first drive transmitting portion A1 also rotates, and the first protrusion 105B that engages therewith moves in the front-back direction (X-axis direction). As illustrated in FIG. 12, in the control apparatus 100 according to this embodiment, when the first operatively connected member 104 is at a predetermined maximum tilt angle, the protruding portion C of the first protrusion 105B may protrude to a region not in contact with the inner surface of the outer clamping piece and above the outer inner end of the outer clamping piece of the pair of clamping pieces 104Ca and 104Cb, which is the end of the inner surface (adjacent to the rotation shaft 104B of the first operatively connected member 104 in the third direction [Z-axis direction]).

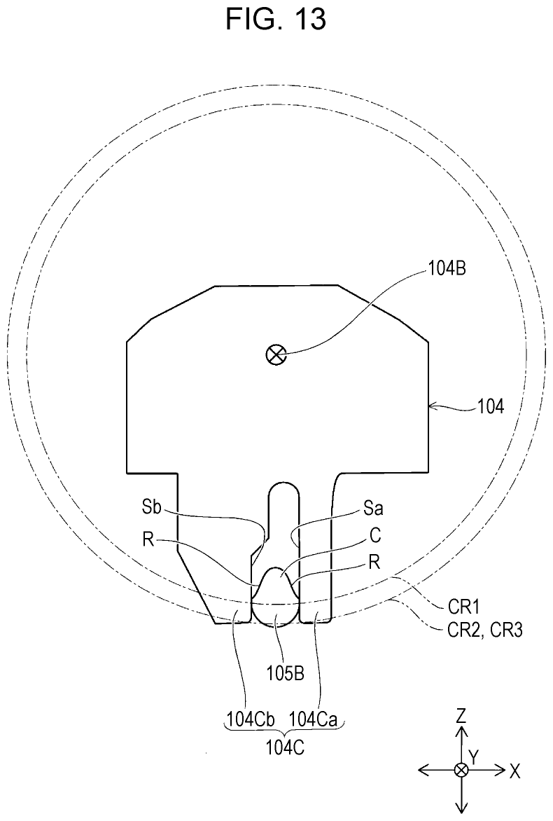

FIGS. 13 to 15 are schematic diagrams illustrating the contact states of the pair of clamping pieces 104Ca and 104Cb and the first protrusion 105B. FIG. 13 illustrates the contact state of the pair of clamping pieces 104Ca and 104Cb and the first protrusion 105B when the lever 120 is at its neutral position. In the state illustrated in FIG. 13, the respective inner surfaces Sa and Sb of the pair of clamping pieces 104Ca and 104Cb are in contact with the central portion (the semicircular portion) of the outer periphery of the first protrusion 105B. A circle CR1 indicated by the dashed-dotted line in the drawing is the trajectory of the circle centered on the rotation shaft 104B, passing through the contact points between the respective inner surfaces Sa and Sb of the pair of clamping pieces 104Ca and 104Cb and the outer periphery of the first protrusion 105B when the lever 120 is at the neutral position.

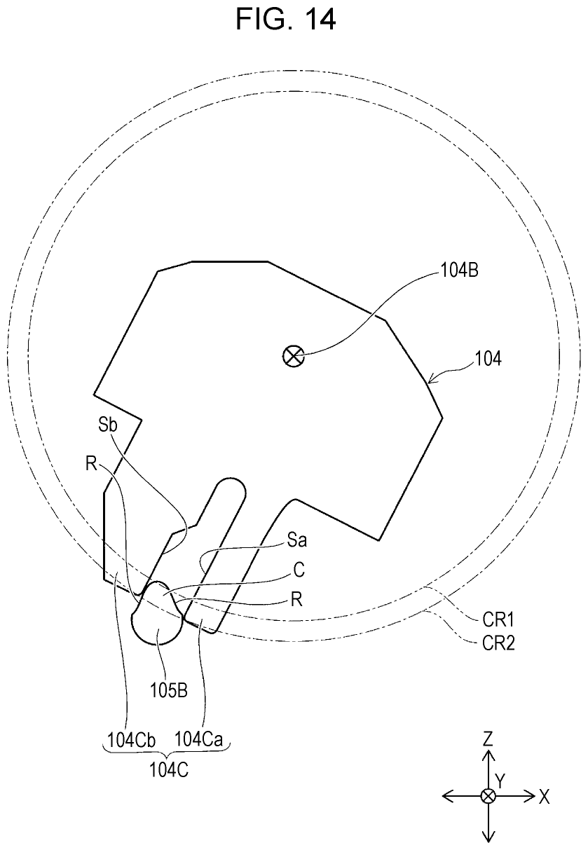

FIG. 14 illustrates the contact state of the pair of clamping pieces 104Ca and 104Cb and the first protrusion 105B when the lever 120 is tilted to the maximum tilt angle on one side in the X-axis direction. In the state illustrated in FIG. 14, the inner surface Sa of one (lower) clamping piece 104Ca of the pair of clamping pieces 104Ca and 104Cb is in contact with the central portion (the semicircular portion) of the outer periphery of the first protrusion 105B, and the inner surface Sb of the other (upper) clamping piece 104Cb is in contact with the outer periphery of the protruding portion C of the first protrusion 105B. A circle CR2 indicated by the dashed-dotted line in the drawing is the trajectory of the circle centered on the rotation shaft 104B, passing through the contact point between the inner surface Sa of one (lower) clamping piece 104Ca of the pair of clamping pieces 104Ca and 104Cb and the outer periphery of the first protrusion 105B when the lever 120 is tilted to the maximum tilt angle on one side in the X-axis direction.

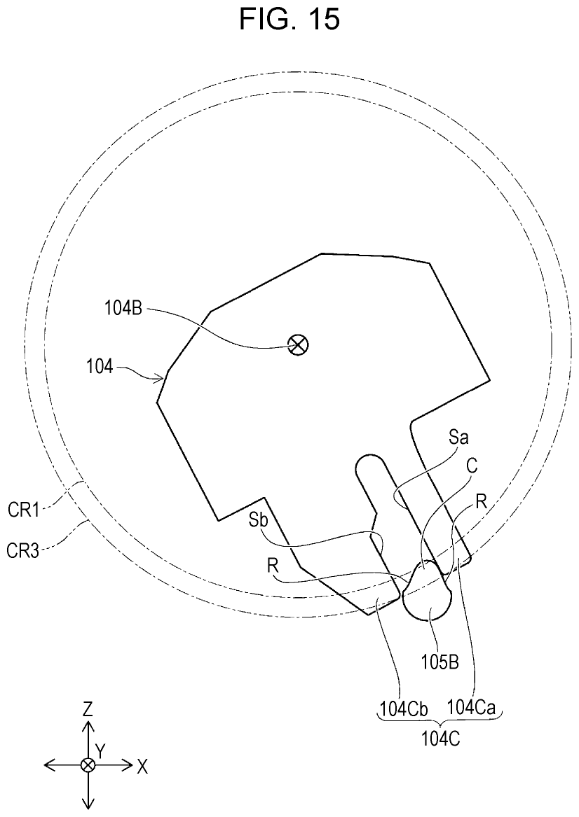

FIG. 15 illustrates the contact state of the pair of clamping pieces 104Ca and 104Cb and the first protrusion 105B when the lever 120 is tilted to the maximum tilt angle on the other side in the X-axis direction. In the state illustrated in FIG. 15, the inner surface Sb of the other (lower) clamping piece 104Cb of the pair of clamping pieces 104Ca and 104Cb is in contact with the central portion (the semicircular portion) of the outer periphery of the first protrusion 105B, and the inner surface Sa of one (upper) clamping piece 104Ca is in contact with the outer periphery of the protruding portion C of the first protrusion 105B. A circle CR3 indicated by the dashed-dotted line in the drawing is the trajectory of the circle centered on the rotation shaft 104B, passing through the contact point between the inner surface Sb of the other (lower) clamping piece 104Cb of the pair of clamping pieces 104Ca and 104Cb and the outer periphery of the first protrusion 105B when the lever 120 is tilted to the maximum tilt angle on the other side in the X-axis direction. Here, the circle CR3 coincides with the circle CR2.

When the first operatively connected member 104 is rotated by the tilting of the lever 120, the first drive transmitting portion A1 changes continuously between the state illustrated in FIG. 13 and the state illustrated in FIG. 14 and between the state illustrated in FIG. 13 and the state illustrated in FIG. 15, in other words, between the state illustrated in FIG. 14 and the state illustrated in FIG. 15 through the state illustrated in FIG. 13.

In the operation of the first drive transmitting portion A1 as described above, in normal use, the inner clamping piece (the lower clamping piece of the pair of clamping pieces 104Ca and 104Cb) applies a force that moves the first protrusion 105B outward while sliding relative to the first protrusion 105B until the lever 120 reaches the maximum tilt angle. For this reason, even if the outer clamping piece (the upper clamping piece of the pair of clamping pieces 104Ca and 104Cb) is in contact with the first protrusion 105B, a force greater than the elastic resilience of the outer clamping piece is not applied to the first protrusion 105B. During the period from the state illustrated in FIG. 13 to the state illustrated in FIG. 14, the clamping piece 104Ca is the inner clamping piece, and the clamping piece 104Cb is the outer clamping piece. During the period from the state illustrated in FIG. 13 to the state illustrated in FIG. 15, the clamping piece 104Cb is the inner clamping piece, and the clamping piece 104Ca is the outer clamping piece.

The circles CR1, CR2, and CR3 illustrated in FIGS. 13 to 15 correspond to the maximum (circles CR2 and CR3) and the minimum (circle CR1) of the circles passing through the contact points between the first protrusion 105B and the inner surfaces of the pair of clamping pieces 104Ca and 104Cb. Thus, the portion of the inner surfaces of the pair of clamping pieces 104Ca and 104Cb located across the circles CR1, CR2, and CR3 are sliding portions in contact with the first protrusion 105B.

In normal use, the first operatively connected member 104 when the lever 120 is at the maximum tilt angle (the state in FIG. 14 or FIG. 15) is subjected to an external force that rotates the lever 120 in the direction in which the tilting angle decreases (the direction in which the first operatively connected member 104 returns to the state illustrated in FIG. 13). At this time, the outer clamping piece of the pair of clamping pieces 104Ca and 104Cb applies a force that moves the first protrusion 105B inward while sliding relative to the first protrusion 105B. For this reason, from the viewpoint of moving the first protrusion 105B in normal use environment, the first protrusion 105B does not need to have the protruding portion C (the portion protruding toward the rotation shaft 104B of the first operatively connected member 104 (upward) in the Z-axis direction beyond the portion facing the outer inner end when at the maximum tilt angle.

However, the outer clamping piece may be temporarily tilted to an angle larger than the maximum tilt angle due to an impact or the like. This state is likely to occur, in particular, when the first protrusion 105B comes into elastic contact with the inner surfaces of the pair of clamping pieces 104Ca and 104Cb so as to expand the gap therebetween even when at least one of the pair of clamping pieces 104Ca and 104Cb is elastically deformable and in normal state.

In such a state, without the protruding portion C, there is a risk that only the first protrusion 105B may move outward. In such a situation, the first protrusion 105B is not located between the pair of clamping pieces 104Ca and 104Cb (i.e., the first protrusion 105B drops out), causing the first drive transmitting portion A1 to malfunction.

For this reason, in the control apparatus 100 according to this embodiment, the first protrusion 105B is provided with the protruding portion C protruding upward (toward the rotation shaft 104B of the first operatively connected member 104 in the third direction [Z-axis direction]). With this configuration, even if the outer clamping piece is tilted beyond intention, the protruding portion C comes into contact with the inner surface of the outer clamping piece, thereby preventing the first protrusion 105B from dropping out.

When the inner surface of the outer clamping piece and the protruding portion C come into contact with each other before the first operatively connected member 104 reaches the maximum tilt angle, the accuracy of measuring the tilt angle may decrease. For this reason, the shape of the protruding portion C is set so that the protruding portion C does not come into contact with the inner surface of the outer clamping piece at the maximum tilt angle. In other words, the protruding portion C may be provided with the recessed portion R. With this configuration, when the pair of clamping pieces 104Ca and 104Cb comes into contact with the first protrusion 105B while rotating, relief for the contact between the first protrusion 105B and the pair of clamping pieces 104Ca and 104Cb is formed. Accordingly, the protruding portion C does not come into contact with the inner surface of the outer clamping piece within the range of the maximum tilt angle, thereby preventing a decrease in the accuracy of measurement of the tilt angle.

The portion where the outer clamping piece and the protruding portion C come into contact with each other when the tilt angle of the lever 120 increases is not limited. In the state at the maximum tilt angle illustrated in FIGS. 14 and 15, the end (the outer inner end) of the inner surface of the outer clamping piece is located at the lowermost point, making it more likely to come into contact with the first protrusion 105B. For this reason, the protruding portion C may be shaped so as to come into contact with the outer clamping piece on the inner surface above the outer inner end. In FIGS. 14 and 15, the recessed portion R serves as a relief, and the outer clamping piece is in contact with the first protrusion 105B at the position above the outer inner end. Such contact may prevent the first protrusion 105B from dropping out with stability because the outer inner end is relatively likely to be plastically deformed or damaged. The shape and the material of the protruding portion C may be set so that the first protrusion 105B does not drop out, due to the elastic deformation of the protruding portion C when the outer clamping piece and the protruding portion C come into contact.

Although the above description has been made using the first drive transmitting portion A1 as an example, the second engaging portion 106C of the second drive transmitting portion A2 may also have a similar configuration.

Thus, the control apparatus 1 according to this embodiment is configured to maintain the reliable operative connection relationship between the members even if a force exceeding the maximum tilt angle of the lever 120 is applied to the lever 120.

Having described the embodiments, it is to be understood that the present invention is not limited to the above examples. For example, although the lever 120 can be tilted about the X-axis and the Y-axis, the lever 120 may be configured to be tilted only about the X-axis (or the Y-axis). It is to be understood that addition, deletion, or design changes of components performed by those skilled in the art on the above embodiments, as well as appropriate combinations of the features of the configurations of the embodiments, are also included within the scope of the present invention as long as they fall within the gist of the present invention.

What is claimed is:

1. A control apparatus comprising:
a lever configured to be tilted;
a strip-shaped first resistor extending in a first direction on a surface of a board;
a first operatively connected member configured to rotate as the lever is tilted; and
a first holder holding a first slider, the first holder sliding the first slider on a surface of the first resistor by moving in the first direction via a first drive transmitting portion as the first operatively connected member rotates,
wherein the first drive transmitting portion includes:
a first protrusion integrated with the first holder and protruding in a second direction perpendicular to the first direction; and
a first engaging portion integrated with the first operatively connected member and including a pair of clamping pieces that clamps the first protrusion from opposite sides in the first direction, and
wherein the first protrusion includes a protruding portion having a third direction component perpendicular to the first direction and the second direction and protruding between the pair of clamping pieces.

2. The control apparatus according to claim 1, wherein, when the first operatively connected member is at a predetermined maximum tilt angle, the protruding portion protrudes to a region not in contact with the inner surface of the outer clamping piece and nearer to a rotation shaft of the first operatively connected member than an outer inner end that is an end of an inner surface of an outer clamping piece of the pair of clamping pieces in the third direction.

3. The control apparatus according to claim 2,
wherein, with the pair of clamping pieces not clamping the first protrusion, in a state in which a distance between one of the pair of clamping pieces and another of the clamping pieces is smaller than a diameter of the first protrusion, and a gap between the pair of clamping pieces extends along the third direction, one of the clamping pieces elastically is deformed to clamp the first protrusion.

4. The control apparatus according to claim 3, wherein the protruding portion protrudes toward the rotation shaft of the first operatively connected member in the third direction beyond the outer inner end in a state in which the outer clamping piece of the first operatively connected member at the maximum tilt angle is most outwardly elastically deformed.

5. The control apparatus according to claim 2,
wherein, as seen along the second direction,
a contour of the first protrusion is circular on a side facing the board in the third direction, and
a contour of the protruding portion protrudes beyond an imaginary line of the circle extending toward the rotation shaft of the first operatively connected member in the third direction.

6. The control apparatus according to claim 5, wherein, as seen along the second direction, the first protrusion includes a recessed portion provided outside the protruding portion in the first direction and having a contour passing inside the imaginary line.
